(19) United States
(12) Patent Application Publication
(10) Pub. No.: US 2008/0154588 A1
(43) Pub. Date: Jun. 26, 2008

(54) Speech Coding System to Improve Packet Loss Concealment

(75) Inventor: Yang Gao, Mission Viejo, CA (US)

Correspondence Address: Yang Gao, 26586 San Torini Rd, Mission Viejo, CA, 92692, US

(73) Assignee: Yang Gao, Mission Viejo, CA (US)

(21) Appl. No.: 11/942,118

(22) Filed: Nov. 19, 2007

Related U.S. Application Data
(60) Provisional application No. 60/877,171, filed on Dec. 26, 2006.
(60) Provisional application No. 60/877,172, filed on Dec. 26, 2006.
(60) Provisional application No. 60/877,173, filed on Dec. 26, 2006.

(51) Int. Cl. G10L 19/12

(52) U.S. Cl. 704/223

(57) ABSTRACT

A method of significantly reducing error propagation due to voice packet loss, while still greatly profiting from long-term pitch prediction, is achieved by adaptively limiting the maximum value of the pitch gain for the first pitch cycle within one frame. A speech coding system for encoding a speech signal, wherein said a plurality of speech frames are classified into said a plurality of classes depending on if the first pitch cycle is included in one subframe or several subframes. The pitch gain is set to a value significantly smaller than 1 for the subframes covering first pitch cycle; wherein the pitch gain reduction is compensated by increasing the coded excitation codebook size or adding one more stage of excitation for the subframes covering the first pitch cycle.

### CROSS REFERENCE TO RELATED APPLICATIONS

### Provisional Application Number US60/877,172

### Provisional Application Number US60/877,173

### BACKGROUND OF THE INVENTION

1. Field of the Invention

The present invention is generally in the field of signal coding. In particular, the present invention is in the field of speech coding and specifically in application where packet loss is an important issue during voice packet transmission.

2. Background Art

Traditionally, all parametric speech coding methods make use of the redundancy inherent in the speech signal to reduce the amount of information that must be sent and to estimate the parameters of speech samples of a signal at short intervals. This redundancy primarily arises from the repetition of speech wave shapes at a quasi-periodic rate, and the slow changing spectral envelop of speech signal.

The redundancy of speech wave forms may be considered with respect to several different types of speech signal, such as voiced and unvoiced. For voiced speech, the speech signal is essentially periodic; however, this periodicity may be variable over the duration of a speech segment and the shape of the periodic wave usually changes gradually from segment to segment. A low bit rate speech coding could greatly benefit from exploring such periodicity. The voiced speech period is also called pitch and pitch prediction is often named Long-Term Prediction. As for the unvoiced speech, the signal is more like a random noise and has a smaller amount of predictability.

In either case, parametric coding may be used to reduce the redundancy of the speech segments by separating the excitation component of the speech from the spectral envelop component. The slowly changing spectral envelope can be represented by Linear Prediction (also called Short-Term Prediction). A low bit rate speech coding could also benefit a lot from exploring such a Short-Term Prediction. The coding advantage arises from the slow rate at which the parameters change. Yet, it is rare for the parameters to be significantly different from the values held within a few milliseconds. Accordingly, at the sampling rate of 8 k Hz or 16 k Hz, the speech coding algorithm is such that the nominal frame duration is in the range of ten to thirty milliseconds. A frame duration of twenty milliseconds seems to be the most common choice. In more recent well-known standards such as G.723, G.729, EFR or AMR, the Code Excited Linear Prediction Technique (“CELP”) has been adopted; CELP is commonly understood as a technical combination of Coded Excitation, Long-Term Prediction and Short-Term Prediction. Code-Excited Linear Prediction (CELP) Speech Coding is a very popular algorithm principle in speech compression area.

FIG. 1 shows the initial CELP encoder where the weighted error 109 between the synthesized speech 102 and the original speech 101 is minimized by using a so-called analysis-by-synthesis approach. W(z) is the weighting filter 110. 1/B(z) is a long-term linear prediction filter 105; 1/A(z) is a short-term linear prediction filter 103. The code-excitation 108, which is also called fixed codebook excitation, is scaled by a gain G_{c} 107 before going through the linear filters.

FIG. 2 shows the initial decoder which adds the post-processing block 207 after the synthesized speech.

FIG. 3 shows the basic CELP encoder which realized the long-term linear prediction by using an adaptive codebook 307 containing the past synthesized excitation 304. The periodic information of pitch is employed to generate the adaptive component of the excitation. This excitation component is then scaled by a gain Gₚ 305 (also called pitch gain). The two scaled excitation components are added together before going through the short-term linear prediction filter 303. The two gains (Gₚ and G_{c}) need to be quantized and then sent to the decoder.

FIG. 4 shows the basic decoder, corresponding to the encoder in FIG. 3, which adds the post-processing block 408 after the synthesized speech.

Long-Term Prediction plays very important role for voiced speech coding because voiced speech has strong periodicity. The adjacent pitch cycles of voiced speech are similar each other, which means mathematically the pitch gain Gₚ in the following excitation express is very high,

e(n)=Gₚ·eₚ(n)+G_{c}·e_{c}(n) (1)

where eₚ(n) is one subframe of sample series indexed by n, coming from the adaptive codebook 307 which consists of the past excitation 304; e_{c}(n) is from the coded excitation codebook 308 (also called fixed codebook) which is the current excitation contribution. For voiced speech, the contribution of eₚ(n) from the adaptive codebook could be dominant and the pitch gain Gₚ 305 is around a value of 1. The excitation is usually updated for each subframe. Typical frame size is 20 milliseconds and typical subframe size is 5 milliseconds. If the previous bit-stream packet is lost and the pitch gain Gₚ is high, the incorrect estimate of the previous synthesized excitation could cause error propagation for quite long time after the decoder has already received the correct bit-stream packet. The partial reason of this error propagation is that the phase relationship between eₚ(n) and e_{c}(n) has been changed due to the previous bit-stream packet loss. One simple solution to solve this issue is just to completely cut (remove) the pitch contribution between frames; this means the pitch gain Gₚ is set to zero in the encoder. Although this kind of solution solved the error propagation problem, it sacrifices too much the quality when there is no bit-stream packet loss or it requires much higher bit rate to achieve the same quality. The invention explained in the following will provide a compromised solution.

### SUMMARY OF THE INVENTION

In accordance with the purpose of the present invention as broadly described herein, there is provided method and system for speech coding.

For most voiced speech, one frame contains more than 2 pitch cycles. If the speech is very voiced, a compromised solution to avoid the error propagation while still profiting from the significant long-term prediction is to limit the pitch gain maximum value for the first pitch cycle of each frame. We can classify speech signal into different cases and treat them differently. For example, Class 1 is defined as (strong voiced) and (pitch<=subframe size); Class 2 is defined as (strong voiced) and (pitch>subframe & pitch<=half frame); Class 3 is defined as (strong voiced) and (pitch>half frame); Class 4 represents all other cases. In case of Class 1, Class 2, or Class 3, for the subframes which cover the first pitch cycle within the frame, the pitch gain is limited to a maximum value (depending on Class) much smaller than 1, and the coded excitation codebook size should be larger than other subframes within the same frame, or one more stage of code-excitation is added to compensate for the lower pitch gain. For other subframes rather than the first pitch cycle subframes, or for Class 4, a regular CELP algorithm is used. The Class index (class number) assigned above to each defined class can be changed without changing the result.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows the initial CELP encoder.

FIG. 2 shows the initial decoder which adds the post-processing block.

FIG. 3 shows the basic CELP encoder which realized the long-term linear prediction by using an adaptive codebook.

FIG. 4 shows the basic decoder corresponding to the encoder in FIG. 3.

FIG. 5 shows an example that the pitch period is smaller than the subframe size.

FIG. 6 shows an example with which the pitch period is larger than the subframe size and smaller than the half frame size.

### DETAILED DESCRIPTION OF THE INVENTION

The present invention discloses a switched long-term pitch prediction approach which improves packet loss concealment. The following description contains specific information pertaining to the Code Excited Linear Prediction Technique (CELP). However, one skilled in the art will recognize that the present invention may be practiced in conjunction with various speech coding algorithms different from those specifically discussed in the present application. Moreover, some of the specific details, which are within the knowledge of a person of ordinary skill in the art, are not discussed to avoid obscuring the present invention.

The drawings in the present application and their accompanying detailed description are directed to merely example embodiments of the invention. To maintain brevity, other embodiments of the invention which use the principles of the present invention are not specifically described in the present application and are not specifically illustrated by the present drawings.

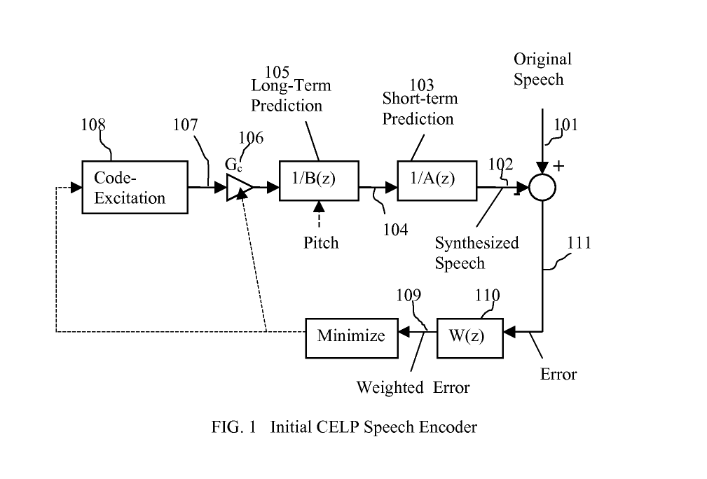

FIG. 1 shows the initial CELP encoder where the weighted error 109 between the synthesized speech 102 and the original speech 101 is minimized often by using a so-called analysis-by-synthesis approach. W(z) is an error weighting filter 110. 1/B(z) is a long-term linear prediction filter 105; 1/A(z) is a short-term linear prediction filter 103. The coded excitation 108, which is also called fixed codebook excitation, is scaled by a gain G_{c} 107 before going through the linear filters. The short-term linear filter 103 is obtained by analyzing the original signal 101 and represented by a set of coefficients:

$$A ( z ) = {\sum }_{i = 1}^{P} 1 + {a}_{i} \cdot {z}^{- i} , i = 1 , 2 , … , P \qquad ( 1 )$$

The weighting filter 110 is somehow related to the above short-term prediction filter. A typical form of the weighting filter could be

$$W ( z ) = \frac{A ( z / α )}{A ( z / β )} , \qquad ( 2 )$$

where β<α, 0<β<1, 0<α≦1. The long-term prediction 105 depends on pitch and pitch gain; a pitch can be estimated from the original signal, residual signal, or weighted original signal. The long-term prediction function in principal can be expressed as

B(z)=1−β·z^{-Pitch} (3)

The coded excitation 108 normally consists of pulse-like signal or noise-like signal, which are mathematically constructed or saved in a codebook. Finally, the coded excitation index, quantized gain index, quantized long-term prediction parameter index, and quantized short-term prediction parameter index are transmitted to the decoder.

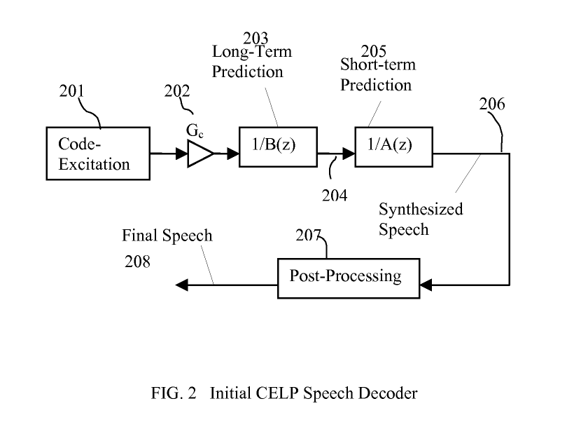

FIG. 2 shows the initial decoder which adds the post-processing block 207 after the synthesized speech 206. The decoder is a combination of several blocks which are coded excitation 201, long-term prediction 203, short-term prediction 205 and post-processing 207. Every block except post-processing has the same definition as described in the encoder of FIG. 1. The post-processing could further consist of short-term post-processing and long-term post-processing.

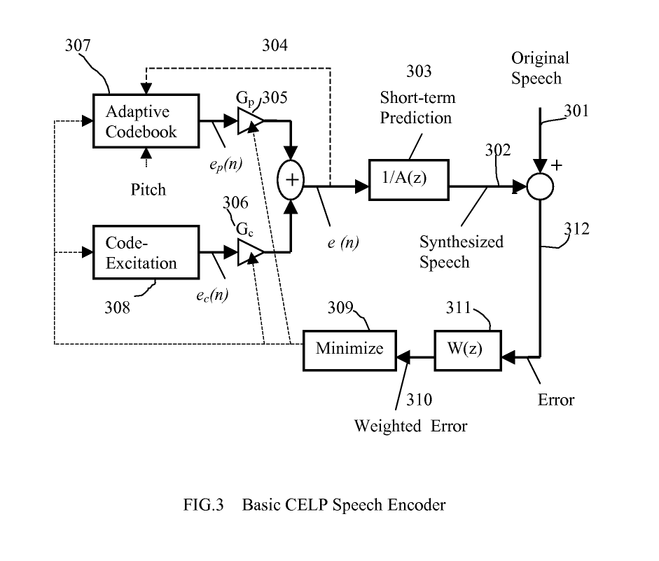

FIG. 3 shows the basic CELP encoder which realized the long-term linear prediction by using an adaptive codebook 307 containing the past synthesized excitation 304. The periodic pitch information is employed to generate the adaptive component of the excitation. This excitation component is then scaled by a gain 305 (Gₚ, also called pitch gain). The two scaled excitation components are added together before going through the short-term linear prediction filter 303. The two gains (Gₚ and G_{c}) need to be quantized and then sent to the decoder.

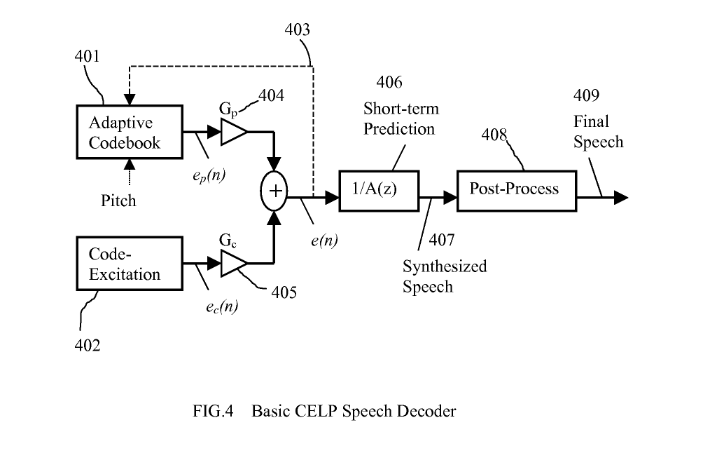

FIG. 4 shows the basic decoder corresponding to the encoder in FIG. 3, which adds the post-processing block 408 after the synthesized speech 407. This decoder is similar to FIG. 2 except the adaptive codebook 307. The decoder is a combination of several blocks which are coded excitation 402, adaptive codebook 401, short-term prediction 406 and post-processing 408. Every block except post-processing has the same definition as described in the encoder of FIG. 3. The post-processing could further consist of short-term post-processing and long-term post-processing.

FIG. 3 illustrates a block diagram of an example encoder capable of embodying the present invention. With reference to FIG. 3 and FIG. 4, the long-term prediction plays very important role for voiced speech coding because voiced speech has strong periodicity. The adjacent pitch cycles of voiced speech are similar each other, which means mathematically the pitch gain Gₚ 305 in the following excitation express is very high,

e(n)=Gₚ·eₚ(n)+G_{c}·e_{c}(n) (4)

where eₚ(n) is one subframe of sample series indexed by n, coming from the adaptive codebook 307 which consists of the past excitation 304; e_{c}(n) is from the coded excitation codebook 308 (also called fixed codebook) which is the current excitation contribution. For voiced speech, the contribution of eₚ(n) from the adaptive codebook 307 could be dominant and the pitch gain Gₚ 305 is around a value of 1. The excitation is usually updated for each subframe. Typical frame size is 20 milliseconds and typical subframe size is 5 milliseconds. If the previous bit-stream packet is lost and the pitch gain Gₚ is high, the incorrect estimate of the previous synthesized excitation could cause error propagation for quite long time after the decoder has already received the correct bit-stream packet. The partial reason of this error propagation is that the phase relationship between eₚ(n) and e_{c}(n) has been changed due to the previous bit-stream packet loss. One simple solution to solve this issue is just to completely cut (remove) the pitch contribution between frames; this means the pitch gain Gₚ 305 is set to zero in the encoder. Although this kind of solution solved the error propagation problem, it sacrifices too much the quality when there is no bit-stream packet loss or it requires much higher bit rate to achieve the same quality. The invention explained in the following will provide a compromised solution.

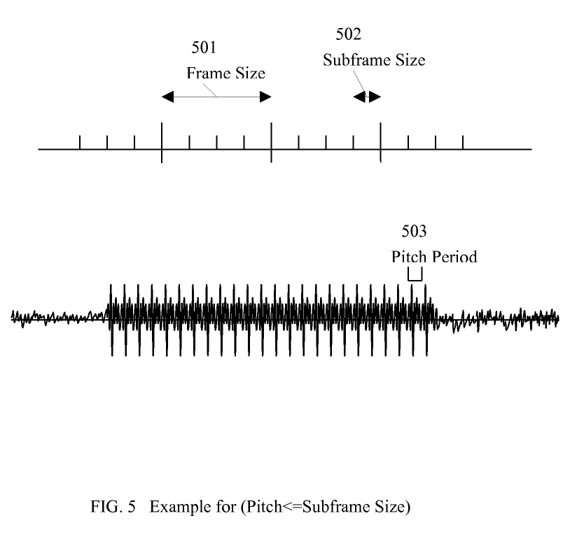

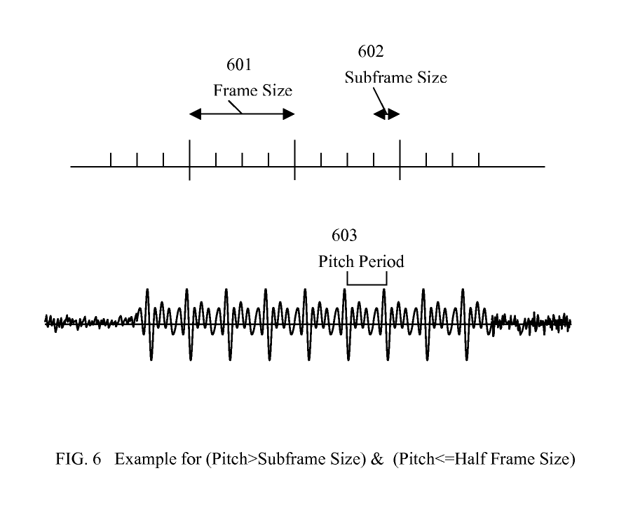

For most voiced speech, one frame contains more than 2 pitch cycles. FIG. 5 shows an example that the pitch period 503 is smaller than the subframe size 502. FIG. 6 shows an example with which the pitch period 603 is larger than the subframe size 602 and smaller than the half frame size. If the speech is very voiced, a compromised solution to avoid the error propagation due to the transmission packet loss while still profiting from the significant long-term prediction gain is to limit the pitch gain maximum value for the first pitch cycle of each frame. We can classify speech signal into different cases and treat them differently. Let's have the following example in which valid speech is classified into 4 classes:

Class 1: (strong voiced) and (pitch<=subframe size). For this frame, the pitch gain of the first subframe is limited to a value (let's say 0.5) much smaller than 1. For the first subframe, the coded excitation codebook size should be larger than other subframes within the same frame, or one more stage of coded excitation is added only for the first subframe, in order to compensate for the lower pitch gain. For other subframes rather than the first subframe, a regular CELP algorithm is used. As this is a strong voiced frame, the pitch track and pitch gain are stable within the frame so that pitch and pitch gain can be encoded more efficiently with less number of bits.
Class 2: (strong voiced) and (pitch>subframe & pitch<=half frame). For this frame, the pitch gains of the first two subframes (half frame) are limited to a value (let's say 0.5) much smaller than 1. For the first two subframes, the coded excitation codebook size should be larger than other subframes within the same frame, or one more stage of code-excitation is added only for the first half frame, in order to compensate for the lower pitch gains. For other subframes rather than the first two subframes, a regular CELP algorithm is used. As this is a strong voiced frame, the pitch track and pitch gain are stable within the frame so that they can be coded more efficiently with less number of bits.
Class 3: (strong voiced) and (pitch>half frame). When the pitch lag is long, the error propagation effect due to the long-term prediction is less significant than short pitch lag case. For this frame, the pitch gains of the subframes covering the first pitch cycle are limited to a value smaller than 1; the coded excitation codebook size could be larger than regular size, or one more stage of coded excitation is added, in order to compensate for the lower pitch gains. Since long pitch lag causes the less error propagation and the probability of having long pitch lag is relatively small, just a regular CELP algorithm can be also used for the entire frame. As this is strong voiced frame, the pitch track and pitch gain are stable within the frame so that they can be coded more efficiently with less number of bits.

### Class 4: all other cases rather than Class 1 Class 2, and Class3. For all the other cases (exclude Class 1, Class 2, and Class 3), a regular CELP algorithm can be used.

The class index (class number) assigned above to each defined class can be changed without changing the result. For example, the condition (strong voiced) and (pitch<=subframe size) can be defined as Class 2 rather than Class 1; the condition (strong voiced) and (pitch>subframe & pitch<=half frame) can be defined as Class 3 rather than Class 2; etc.

In general, the error propagation effect due to speech packet loss is reduced by adaptively diminishing pitch correlations at the boundary of speech frames while still keeping significant contributions from the long-term pitch prediction.

The present invention may be embodied in other specific forms without departing from its spirit or essential characteristics. The described embodiments are to be considered in all respects only as illustrative and not restrictive. The scope of the invention is, therefore, indicated by the appended claims rather than the foregoing description. All changes which come within the meaning and range of equivalency of the claims are to be embraced within their scope.

What is claimed is:

1. A method of significantly reducing error propagation due to voice packet loss, while still greatly profiting from long-term pitch prediction, is achieved by adaptively limiting the maximum value of the pitch gain for the first pitch cycle within one frame, said one speech frame having a plurality of pitch cycles.

2. The method of claim 1 further comprising the steps of: making the pitch gain of the first pitch cycle significantly smaller than 1; compensating the pitch gain reduction by increasing the coded excitation codebook size or adding one more stage of excitation for the first pitch cycle.

3. The method of claim 2 further setting the pitch gain to a value about 0.5 for the first pitch cycle.

4. The method of claim 2 further keeping the regular pitch gain and the regular coded excitation codebook size for other pitch cycles rather than the first pitch cycle.

5. The method of claim 2, wherein the adaptive pitch gain limitation for the first pitch cycle within one frame is employed for said strong voiced speech.

6. A speech coding system for encoding a speech signal, said speech signal having a plurality of frames, each of said plurality of frames having a plurality of pitch cycles, wherein said a plurality of frames are classified into said a plurality of classes depending on if the first pitch cycle is included in one subframe or several subframes.

7. The method of claim 6 further comprising the steps of: making the pitch gain significantly smaller than 1 for the subframes covering first pitch cycle; compensating the pitch gain reduction by increasing the coded excitation codebook size or adding one more stage of excitation for the subframes covering the first pitch cycle.

8. The method of claim 7 further setting the pitch gain to a value about 0.5 for the subframes covering the first pitch cycle.

9. The method of claim 7 further keeping the regular pitch gain and the regular coded excitation codebook size for other subframes rather than the subframes covering the first pitch cycle.

10. The method of claim 7, wherein the adaptive pitch gain limitation for the subframes covering the first pitch cycle within one frame is employed for said strong voiced speech.
